(19) United States
(12) Patent Application Publication
(10) Pub. No.: US 2015/0284816 A1
(43) Pub. Date: Oct. 8, 2015

(54) SLAG REMOVAL DEVICE

(71) Applicant: MITSUBISHI HEAVY INDUSTRIES, LTD., Tokyo (JP)

(72) Inventors: Masakazu Sakaguchi, Tokyo (JP); Tsutomu Hamada, Tokyo (JP); Takeshi Okada, Tokyo (JP); Setsuo Omoto, Tokyo (JP); Keiichi Nakagawa, Tokyo (JP)

(73) Assignee: MITSUBISHI HEAVY INDUSTRIES, LTD., Tokyo (JP)

(21) Appl. No.: 14/417,946

(22) PCT Filed: Sep. 10, 2013
(86) PCT No.: PCT/JP2013/074411

§ 371 Date: Jan. 28, 2015

(30) Foreign Application Priority Data
Sep. 20, 2012 (JP) 2012-207271

(51) Int. Cl. C21B 7/16; F27B 1/26; F27B 1/16; C21B 5/00; F27D 25/00

(52) U.S. Cl. CPC C21B 7/163; C21B 5/006; C21B 5/003; F27D 25/008; F27B 1/16; F27B 1/26

(57) ABSTRACT

Provided is a slag removal device for a blow pipe, that reduces the risk of pipe breakage, etc., and is capable of achieving easy and reliable slag removal using a simple device configuration. The slag removal device comprises a blow pipe (30) that injects auxiliary fuel pulverized coal, together with hot air, from a tuyere (22) for a blast furnace main body (20) that produces pig iron from iron ore. The slag removal device for a blow pipe including a component that melts on to the pulverized coal slag as a result of the hot air and/or the combustion heat of the pulverized coal comprises a fluid jet nozzle (80) that sprays fluid towards a slag adhesion area inside the blow pipe (30).

### TECHNICAL FIELD

The present invention relates to a slag removal device for a blow pipe for use in a blast furnace facility, and, in particular, to a slag removal device that can be advantageously used for a blow pipe for injecting pulverized coal obtained by pulverizing low-grade coal into a furnace as an auxiliary fuel together with hot air.

### BACKGROUND ART

A blast furnace facility has been configured so as to be capable of producing pig iron from iron ore by introducing a starting material such as iron ore, limestone, and coal from the top into the interior of a blast furnace main body and injecting hot air and pulverized coal (pulverized coal injection: PCI coal) as an auxiliary fuel from a tuyere disposed at a lower portion on the side of the blast furnace main body.

In such a blast furnace facility, if low-grade coal generally having a low ash melting point of 1,100 to 1,300° C., such as sub-bituminous coal or lignite, is used as the pulverized coal during the operation of injecting pulverized coal, the oxygen contained in the hot air having roughly 1,200° C., the hot air being used to inject the pulverized coal into the furnace, and a portion of the pulverized coal engages in a combustion reaction. The combustion heat generated thereby causes ash (hereafter, called “slag”) having a low melting point to melt within the injection lance or tuyere.

The melted slag is rapidly cooled through contact with the tuyere, which is constantly cooled in order to be protected from the temperature of the blast furnace. As a result, solid slag adheres to the tuyere, leading to the problem of blockage of the flow path of the blow pipe.

Conventionally known methods for removing slag adhering to the inner circumferential surfaces of blast tuyeres or insulation rings include those disclosed in Patent Documents listed below.

The method disclosed in Patent Document 1 involves removing slag by injecting hard balls into a tuyere from the end on the furnace-exterior side of the tuyere.

The conventional technique disclosed in Patent Document 2 involves a worker inserting a steel rod or the like through a port and knocking out a tuyere-blocking material used to prevent the tuyere from being eroded in order to remove the tuyere-blocking material.

The conventional technique disclosed in Patent Document 3 involves using a rock drill to form a guide hole passing through a tuyere-blocking material used to prevent a tuyere from being eroded, followed by shot-blasting an abrasive material at the guide hole to abrade away the rest in order to remove the blocking material.

### CITATION LIST

### Patent Documents

Patent Document 1: Japanese Unexamined Patent Application Publication No. H6-192714A

Patent Document 2: Japanese Unexamined Patent Application Publication No. H11-50115A

Patent Document 3: Japanese Unexamined Patent Application Publication No. 2001-342508A

### SUMMARY OF THE INVENTION

### Technical Problem

However, in the method disclosed in Patent Document 1, there is no guarantee that all of the hard balls will impact the slag. Thus, if there are any hard balls that do not impact the slag, these balls will directly impact the inner surface of the blow pipe, creating the risk of problematic damage to the pipe or the like from the impact of the balls. In Patent Document 1, the slag to be broken using the hard balls is formed on blast tuyeres and insulation rings.

The methods disclosed in Patent Documents 2 and 3 require manual labor, making them problematic in terms of ease of operation.

In view of these circumstances, there is a demand for a slag removal device for a blow pipe for use in a blast furnace facility that can reduce the risk of pipe damage and the like and allows for easy and reliable slag removal using as simple a device configuration as possible.

The present invention has been conceived in order to solve the problems described above, and an object thereof is to provide a slag removal device for a blow pipe that can reduce the risk of pipe damage and the like and allows slag to be easily and reliably removed using a simple device configuration.

### Solution to Problem

In order to solve the problems described above, the present invention employs the following means.

A slag removal device according to one aspect of the present invention is a slag removal device for a blow pipe including a blow pipe for injecting pulverized coal as an auxiliary fuel together with hot air from a tuyere of a blast furnace main body for producing pig iron from iron ore, slag from the pulverized coal containing a component that is melted by the hot air and/or heat from combustion of the pulverized coal, includes a fluid jet nozzle for spraying fluid towards a slag adhesion area within the blow pipe.

In accordance with this slag removal device for a blow pipe according to one aspect of the present invention, the latent heat of vaporization of the fluid is effectively utilized to rapidly cool the adhering slag, allowing the solid slag to be broken and removed via thermal shrinkage.

In the invention described above, the fluid is preferably a combustible fluid.

In such an arrangement, the combustible fluid combusts once the combustible fluid has rapidly cooled the slag, allowing the hot air to be heated.

In the invention described above, it is preferable that the fluid jet nozzle includes a fluid supply system that supplies the fluid and is provided with an opening/closing control valve, and a slag detection means for detecting the state of slag within the slag adhesion area; that the opening/closing control valve be opened and the fluid is sprayed when a slag adhesion level detected by the slag detection means is determined to be at or above a slag removal threshold value; and that the opening/closing control valve be closed and spraying of the fluid is stopped when the slag adhesion level detected by the slag detection means is less than a slag removal stop threshold value.

Such an arrangement allows the fluid to be sprayed from the fluid jet nozzle only when necessitated by high slag adhesion levels.

In the invention described above, it is preferable that the slag adhesion level be determined from a pressure differential between hot air pressure upstream of the fluid jet nozzle and hot air pressure near an outlet of the blow pipe.

Such an arrangement allows for the reliable detection of reductions in the cross-sectional area of a flow path and increases in blow pipe pressure loss caused by increased slag adhesion levels.

In the invention described above, it is preferable that there be provided an alarm output threshold value set to a value at which the slag adhesion level is greater than the slag removal threshold value.

Such an arrangement makes it possible to detect when slag removal is not being performed by the fluid jet nozzle as planned.

### Advantageous Effects of Invention

In according with the slag removal device according to the present invention described above, the latent heat of vaporization of the fluid is utilized to rapidly cool the slag, and solidified adhering slag is broken and removed via thermal shrinkage, reducing the risk of pipe damage and the like that are a concern when hard balls or the like are used to remove slag, and allowing slag to be easily and reliably removed via a simple device configuration in which fluid is sprayed from a nozzle.

As a result, even low-grade coals having low ash melting points of 1,100 to 1,300° C., such as sub-bituminous coal or lignite, can be used as the pulverized coal constituting the auxiliary fuel through upgrading to result in feedstock coal. Specifically, oxygen in the roughly 1,200° C. hot air used to inject the auxiliary fuel engages in a combustion reaction with the pulverized coal, and low melting point slag melted by the combustion heat produced by this combustion reaction comes into contact with and is rapidly cooled by the cold tuyere; thus, even if the slag is solidified and adheres to the tuyere, the adhering slag can easily be broken and removed by spraying the fluid, preventing the flow path of the blow pipe from being clogged.

### BRIEF DESCRIPTION OF THE DRAWINGS

FIG. 1 is a schematic configuration diagram illustrating an embodiment of a slag removal device according to the present invention.

FIG. 2 is a magnified view of the essential parts of the slag removal device illustrated in FIG. 1.

FIG. 3 is an illustration of an example configuration for a blast furnace facility to which the slag removal device illustrated in FIG. 1 is applied.

### DESCRIPTION OF EMBODIMENTS

An embodiment of the slag removal device according to the present invention will now be described with reference to the drawings.

The slag removal device according to the present embodiment is used in a blast furnace facility in which pulverized low-grade coal constituting feedstock coal is injected from a tuyere into a blast furnace together with hot air.

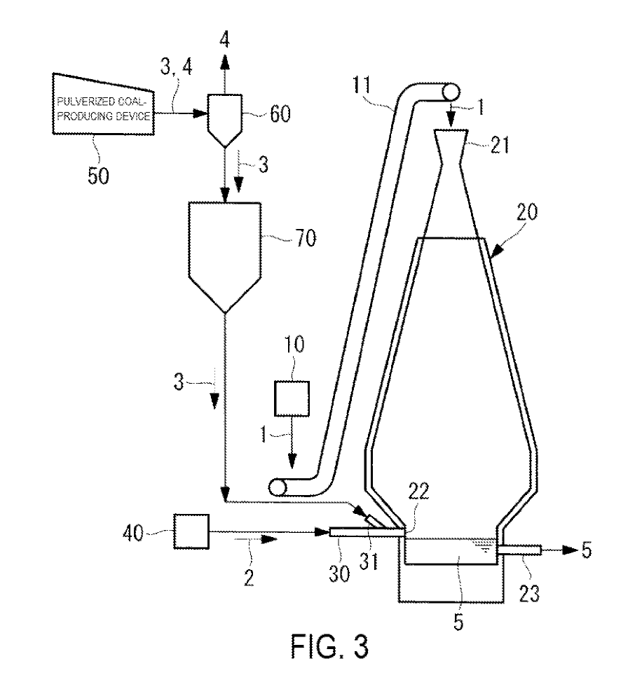

For example, in a blast furnace facility as illustrated in FIG. 3, a starting material 1 constituted by iron ore, limestone, coal and the like is fed from a starting material dispensing device 10 via a transport conveyor 11 into a furnace top hopper 21 provided on the top of a blast furnace main body 20. A plurality of tuyeres 22 is provided on a lower side wall of the blast furnace main body 20 at a roughly uniform pitch in the circumferential direction. Each of the tuyeres 22 is linked to a downstream end of a blow pipe 30 for feeding hot air 2 into the blast furnace main body 20. The upstream end of each of the blow pipes 30 is connected to a hot air feeding device 40 constituting the source of the hot air 2 which is fed into the blast furnace main body 20.

A pulverized coal producing device 50 that performs a pretreatment (upgrading) such as evaporating moisture in the coal out of the feedstock coal (sub-bituminous coal, lignite, or other low-grade coal), followed by pulverizing the low-grade coal to produce pulverized coal, is provided near the blast furnace main body 20.

Upgraded pulverized coal (upgraded coal) 3 produced by the pulverized coal producing device 50 is conveyed by a carrier gas 4, such as nitrogen gas, to a cyclone separator 60. The pulverized coal 3 conveyed by the gas is separated from the carrier gas 4 by the cyclone separator 60, after which the coal falls into and is stored in a storage tank 70. This upgraded pulverized coal 3 is used as blast furnace injection coal (PCI coal) for the blast furnace main body 20.

The pulverized coal 3 within the storage tank 70 is fed into an injection lance (hereafter, called “lance”) 31 of the blow pipe 30 described above. The pulverized coal 3 combusts upon being fed into the hot air flowing through the blow pipe 30, producing a flame at the end of the blow pipe 30 and forming a raceway. This causes the coal and the like contained in the starting material 1 being introduced into the blast furnace main body 20 to combust. As a result, the iron ore contained in the starting material 1 is reduced to result in pig iron (molten iron) 5, which is drawn out from a taphole 23.

Preferred properties of the pulverized coal 3 fed from the lance 31 into the blow pipe 30 as blast furnace injection coal, that is, of the upgraded pulverized coal (auxiliary fuel) formed by upgrading and pulverizing low-grade coal, are that an oxygen atom content (dry basis) is from 10 to 18 wt %, and an average pore size is from 10 to 50 nm (nanometers). A more preferable average pore size for the upgraded pulverized coal is from 20 to 50 nm (nanometers).

In pulverized coal 3 having such properties, there is a large release of and reduction in tar-forming groups of oxygen-containing functional groups (carboxyl groups, aldehyde groups, ester groups, hydroxyl groups, etc.) but decomposition (reduction) of the main structure (the combustible component primarily formed from carbon, hydrogen, and oxygen) is greatly suppressed. Thus, when the coal is injected from the tuyeres 22 into the blast furnace main body 20 together with the hot air 2, the high oxygen atom content of the main structure and the large diameter of the pores not only facilitates dispersion of the oxygen in the hot air 2 into the coal, but also greatly impedes the generation of tar, allowing for complete combustion with almost no uncombusted carbon (soot) being produced.

In order to produce (upgrade) this pulverized coal 3, a drying step of heating (at from 110 to 200° C. for from 0.5 to 1 hour) and drying low-grade coal (dry-basis oxygen atom content: greater than 18 wt %; average pore size: from 3 to 4 nm), such as sub-bituminous coal or lignite, constituting the feedstock coal in a low-oxygen atmosphere having an oxygen concentration of 5 vol % or less is performed in the pulverized coal producing device 50 described above.

After moisture is removed in the drying step described above, a pyrolysis step in which the feedstock coal is reheated (at from 460 to 590° C., preferably from 500 to 550° C., for from 0.5 to 1 hour) in a low-oxygen atmosphere (oxygen concentration: 2 vol % or less) is performed. Pyrolyzing the feedstock coal in this pyrolysis step removes generated water, carbon dioxide, and tar in the form of pyrolysis gas or pyrolysis oil.

The feedstock coal then proceeds to a cooling step in which the coal is cooled (to 50° C. or less) in a low-oxygen atmosphere having an oxygen concentration of 2 vol % or less, then pulverized (particle diameter: 77 μm or less (80% pass)) in a pulverization step.

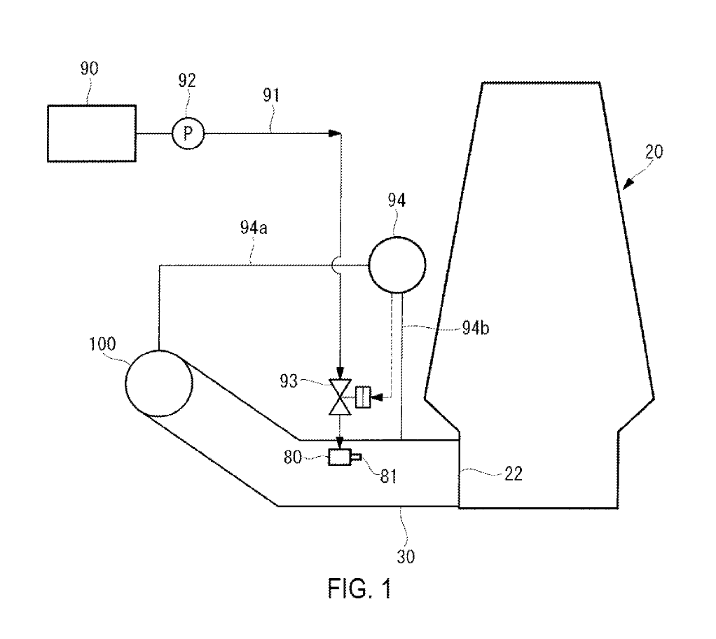

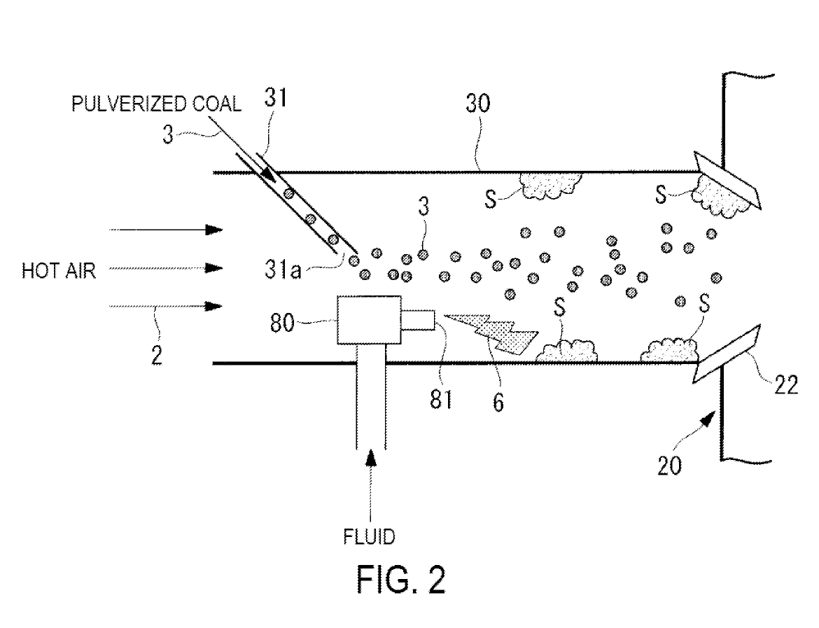

The present embodiment, as illustrated, for example, in FIGS. 1 and 2, is provided with a fluid jet nozzle 80 for spraying fluid 6 into the blow pipe 30 in order to remove slag S adhering to the inner wall surface of the blow pipe 30 and the inner wall surfaces of the tuyere 22 and vicinity thereof constituting slag adhesion areas. The fluid jet nozzle 80 effectively utilizes the latent heat of vaporization of the fluid to rapidly cool slag adhering to the blow pipe 30 and near the tuyere 22, with one or a plurality thereof being provided, as appropriate, along, for example, the inner circumferential surface of the blow pipe 30.

Examples of preferred fluids 6 that are sprayed from the fluid jet nozzle 80 include water and combustible fluids such as heavy oil.

To keep the opening of the outlet on a nozzle tip 81 from which the fluid is sprayed from being clogged with pulverized coal 3, slag S, or the like, the fluid jet nozzle 80 is preferably disposed at a position roughly aligned, with respect to the axial direction of the blow pipe 30, with a distal end 31a of the lance 31 from which the pulverized coal 3 is fed. In such cases, the nozzle tip 81 of the fluid jet nozzle 80 preferably has a nozzle shape for spraying the fluid in a linear shape in the direction of the tuyere 22, and an arrangement in which the spraying direction can be altered may be adopted, as necessary. If an arrangement in which the spraying direction of the nozzle end 81 can be altered is adopted, the pressure at which the fluid is supplied, for instance, can be used to swing or rotate the nozzle.

The position with respect to the radial direction at which the fluid jet nozzle 80 is disposed is preferably close to the side wall of the blow pipe 30 so as not to resist the flow path of the hot air 2 and so that the nozzle is capable of directly spraying at slag S adhering to the side wall of the blow pipe 30.

The fluid jet nozzle 80 is connected to a fluid supply source 90 via a fluid supply pipe 91. The fluid supply pipe 91 is provided with, as primary constituent elements, a pump 92 for pressure-feeding fluid in the fluid supply source 90 to the fluid jet nozzle 80, and a control valve 93 for controlling the supply (on/off) of fluid to the fluid jet nozzle 80 by switching between open and closed states.

The control valve 93 is opened or closed according to the value of a pressure differential ΔP measured by a differential pressure gauge 94. Two pressure intake pipes 94a, 94b are connected to the differential pressure gauge 94 so as to measure the pressure differential ΔP between, for example, a main hot air pipe 100 and a blow pipe downstream position near the tuyere 22 of the blow pipe 30.

As described above, the fluid jet nozzle 80 is provided with a fluid supply system that supplies the fluid being sprayed and includes the control valve (opening/closing control valve) 93, and the differential pressure gauge (slag detection means) 94 for detecting the state of slag within the slag adhesion area.

The slag adhesion level is determined from the pressure differential between the hot air pressure upstream of the fluid jet nozzle 80 and the hot air pressure near the outlet of the blow pipe 30.

Specifically, when there is slag S adhering to the inner wall surface of the blow pipe 30 or near the tuyere 22, the reduction in the cross-sectional area of the flow path of the blow pipe 30 creates a pressure loss, leading to a reduction in the pressure of the flow of hot air from the main hot air pipe 100 to the blast furnace main body 20. Thus, the pressure intake pipe 94a connected to the main hot air pipe 100 and the pressure intake pipe 94b connected to the blow pipe downstream position of the blow pipe 30 are used to measure the pressure differential ΔP in the hot air 2 before and after the slag adhesion area using the differential pressure gauge 94, and the size of the pressure differential ΔP is used to estimate the slag S adhesion state.

The pressure differential ΔP so measured is compared to a preset threshold value, and used in opening and closing the control valve 93 described above.

The following is a detailed description of the threshold value for the pressure differential ΔP and the process of controlling the opening and closing of the control valve 93 based on the pressure differential ΔP measured by the differential pressure gauge 94. When the control valve 93 is in an open state, the operation of the pump 92 is started so that fluid is sprayed from the fluid jet nozzle 80.

In the present embodiment, two threshold values are set; namely, a first threshold value (slag removal threshold value) HL for opening the control valve 93 when the valve is in a closed state, and a second threshold value (slag removal stop threshold value) LL for closing the control valve 93 when the valve is in an open state.

In other words, the first threshold value (slag removal threshold value) HL is used to open the control valve 93 provided as an opening/closing control valve and spray the fluid when the slag adhesion level detected by the differential pressure gauge 94 constituting the slag detection means is determined to be at or above the slag removal threshold value.

The second threshold value (slag removal stop threshold value) LL is used to close the control valve 93 and stop spraying the fluid when the slag adhesion level detected by the differential pressure gauge 94 constituting the slag detection means is determined to be less than the slag removal stop threshold value.

The control valve 93 is set to the closed state when operation starts (i.e., at the initial setting), when there is no slag S adhesion, and the pressure differential ΔP detected by the differential pressure gauge 94 is lower than the second threshold value LL, with there being almost no pressure differential (ΔP≈0).

As the operation of the blast furnace facility continues from the state at the initial setting described above, slag S gradually adheres to and accumulates on the side wall surfaces of the blow pipe 30 and the tuyere 22, with the result that the flow path resistance also gradually increases due to the reduction in the cross-sectional area of the flow path. Thus, when the value of the pressure differential ΔP detected by the differential pressure gauge 94 increases to the first threshold value, this is detected by the differential pressure gauge 94, which outputs an open signal to the control valve 93.

The control valve 93 is opened in response to the open signal, and, simultaneously, the pump 92 is started. As a result, the fluid stored in the fluid supply source 90 is sprayed from the fluid jet nozzle 80 into the blow pipe 30, and, when the sprayed fluid comes into contact with the adhering slag S, the latent heat of vaporization thereof is lost, rapidly cooling the slag. This rapid cooling causes the slag S, which is a vitreous, brittle solid, to rapidly undergo thermal shrinkage, breaking and removing the slag S from the side wall surface. Specifically, the slag S, having been broken into comparatively small chunks, is removed to the interior of the blast furnace main body 20 by the flow of hot air 2 and fluid.

Removing the slag S in this way reduces the flow path resistance as the cross-sectional area of the flow path increases, reducing the pressure differential ΔP detected by the differential pressure gauge 94. When the pressure differential ΔP detected by the differential pressure gauge 94 decreases to the second threshold value LL, a close signal is outputted to the control valve 93. The control valve 93 is closed by this close signal, and, simultaneously, the operation of the pump 92 is stopped.

The first threshold value HL described above is set to a slightly greater value (i.e., HL>LL) in order to create hysteresis between the first threshold value HL and the second threshold value LL used to open the control valve 93 to prevent frequent opening and closing of the control valve 93.

In this way, the provision of the fluid jet nozzle 80, which utilizes the latent heat of vaporization of the fluid to rapidly cool the slag S, eliminates the need for blast equipment or the like for injecting hard balls or abrasive material. In addition, the water, combustible fluid, or other fluid is converted to water vapor or combustion gas after being sprayed, greatly facilitating after-treatment following slug removal.

In particular, if heavy oil or another combustible fluid is used as the fluid, the combustion of the combustible fluid further raises the temperature of the hot air.

In the embodiment described above, two threshold values, i.e., the first threshold value HL for opening the control valve 93 when the valve is in a closed state and the second threshold value LL for closing the control valve 93 when the valve is in an open state, are set, but a third threshold value HHL may also be set.

The third threshold value HHL is greater than the first threshold value HL for opening the control valve 93 when the valve is in a closed state (i.e., HHL>HL); if a pressure differential ΔP in excess of this threshold value HHL is detected, it can be assumed that there is a problem in removing the slag S, or the like. Thus, if the pressure differential ΔP exceeds the third threshold value

HHL, an alarm is outputted, for example, to a control room of the blast furnace facility so that the necessary measures can be taken forthwith, allowing major problems in the blast furnace facility, such as damage to the blow pipe 30, to be prevented before they occur. In other words, the third threshold value HHL is an alarm output threshold value set to a value at which the slag adhesion level is greater than the first threshold value (slag removal threshold value) HL described above.

As described above, the slag removal device according to the present embodiment is for a blow pipe, which is provided with a blow pipe 30 for injecting pulverized coal as an auxiliary fuel together with hot air from a tuyere 22 of a blast furnace main body 20 for producing pig iron from iron ore, slag from the pulverized coal containing a component that is melted by the hot air and/or heat from combustion of the pulverized coal, and is provided with a fluid jet nozzle 80 for spraying fluid towards a slag adhesion area within the blow pipe 30.

Thus, the fluid jet nozzle 80 constitutes a slag removal device that effectively utilizes the latent heat of vaporization of the fluid to rapidly cool adhering slag, breaking and removing the solid slag via thermal shrinkage.

As a result, the adhering slag S can be broken and removed without having to adjust the softening point of the pulverized coal 3, allowing, for example, the maintenance interval of the blow pipe 30 to be extended to the wear lifespan of the tuyere 22.

The component that is contained in the slag S from the pulverized coal 3 described above and is melted by the hot air 2 or the heat produced by the combustion of the pulverized coal 3, i.e., the low melting point slag component, has an ash melting point of roughly from 1,100 to 1,300° C. when hot air 2 of roughly 1,200° C. is used. Such a low melting point slag component is also contained in upgraded coal produced by upgrading low-grade coal, such as sub-bituminous coal or lignite, used as the feedstock coal for the pulverized coal 3 via drying, pyrolysis, or the like.

The present invention is not limited to the embodiment described above, and various modifications may be made thereto, as appropriate, within the scope of the invention.

### REFERENCE SIGNS LIST

1 Starting material

2 Hot air

3 Pulverized coal (upgraded coal)

4 Carrier gas

5 Pig iron (molten iron)

6 Fluid

10 Starting material dispensing device

20 Blast furnace main body

21 Furnace top hopper

22 Tuyere

30 Blow pipe

31 Injection lance (lance)

40 Hot air feeding device

50 Pulverized coal producing device

60 Cyclone separator

70 Storage tank

80 Fluid jet nozzle

81 Nozzle tip

90 Fluid supply source

92 Pump

93 Control valve

94 Differential pressure gauge

S Slag (ash)

1. A slag removal device for a blow pipe for injecting pulverized coal as an auxiliary fuel together with hot air from a tuyere of a blast furnace main body for producing pig iron from iron ore, by which slag from the pulverized coal containing a component that is melted by the hot air and/or heat from combustion of the pulverized coal is removed, comprising a fluid jet nozzle for spraying fluid towards a slag adhesion area within the blow pipe.

2. The slag removal device according to claim 1, wherein the fluid is a combustible fluid.

3. The slag removal device according to claim 1, wherein the fluid jet nozzle includes a fluid supply system for supplying the fluid, the fluid supply system including an opening/closing control valve, and slag detection means for detecting a state of slag within the slag adhesion area; wherein the opening/closing control valve is opened and the fluid is sprayed upon a slag adhesion level detected by the slag detection means being determined to be at or above a slag removal threshold value, and the opening/closing control valve is closed and spraying of the fluid is stopped upon the slag adhesion level detected by the slag detection means being less than a slag removal stop threshold value.

4. The slag removal device according to claim 3, wherein the slag adhesion level is determined from a pressure differential between hot air pressure upstream of the fluid jet nozzle and hot air pressure near an outlet of the blow pipe.

5. The slag removal device according to claim 3, wherein there is provided an alarm output threshold value set to a value at which the slag adhesion level is greater than the slag removal threshold value.

6. The slag removal device according to claim 2, wherein the fluid jet nozzle includes a fluid supply system for supplying the fluid, the fluid supply system including an opening/closing control valve, and slag detection means for detecting a state of slag within the slag adhesion area; wherein the opening/closing control valve is opened and the fluid is sprayed upon a slag adhesion level detected by the slag detection means being determined to be at or above a slag removal threshold value, and the opening/closing control valve is closed and spraying of the fluid is stopped upon the slag adhesion level detected by the slag detection means being less than a slag removal stop threshold value.

7. The slag removal device according to claim 6, wherein the slag adhesion level is determined from a pressure differential between hot air pressure upstream of the fluid jet nozzle and hot air pressure near an outlet of the blow pipe.

8. The slag removal device according to claim 4, wherein there is provided an alarm output threshold value set to a value at which the slag adhesion level is greater than the slag removal threshold value.

9. The slag removal device according to claim 7, wherein there is provided an alarm output threshold value set to a value at which the slag adhesion level is greater than the slag removal threshold value.
